(19) United States
(12) Patent Application Publication
(10) Pub. No.: US 2017/0022756 A1
(43) Pub. Date: Jan. 26, 2017

(54) SAFETY BEAD CHAIN FOR BLINDS

(71) Applicant: UNI-SOLEIL ENT.CO., LTD., TAINAAN CITY (TW)

(72) Inventor: YU-TING KAO, TAINAN CITY (TW)

(21) Appl. No.: 14/808,151

(22) Filed: Jul. 24, 2015

(51) Int. Cl. E06B 9/326; E06B 9/78

(52) U.S. Cl. CPC E06B 9/326; E06B 9/78; E06B 2009/3265; E06B 2009/785

(57) ABSTRACT

A safety bead chain for blinds is revealed. An external member and a mounting member are disposed on two ends of the bead chain respectively. The external member consists of a groove and at least two first locking parts arranged around the groove. The mounting member is set with at least two second locking parts locked with the first locking parts correspondingly. Thus the external member and the mounting member are locked with each other to form a safety bead fastener bead with the same shape as a bead of the bead chain. The two ends of the bead chain are released from each other once a pulling force is applied to the bead chain to keep children from getting tangled in the bead chain. Moreover, the bead chain is moved around the clutch in a circular manner. Users can operate the bead chain more conveniently.

### BACKGROUND OF THE INVENTION

Field of the invention

The present invention relates to a bead chain for blinds, especially to a safety bead chain for blinds in which two ends thereof are separated when a force applied is larger than load of the bead chain. Moreover, the bead chain is moved around a sprocket in a circular manner.

Descriptions of Related Art

A blind cord or a bead chain is used to roll the blinds up and down or move the blinds horizontally. In a conventional blind, a fabric is wound around a roller. The roller is connected to a clutch while a bead chain/cord is arranged at the clutch. The roller is further driven by the clutch to rotate clockwise or counterclockwise when the clutch is driven by the bead chain being pulled. Thus the blind is raised or lowered by the chain-driven clutch.

However, the bead chain is a circular chain with high toughness.

While playing, a cord/chain for blinds may be wrapped around children's neck can tighten and strangle them instantly. In recent years, there have been several deaths caused by blind cord/chain.

In order to reduce the risk posed by the cord/chain mentioned above, several safety devices for blinds have been invented. Refer to TW M485682 U, a safety fastener structure for a bead chain pull cord is revealed. Refer to TW M400280 U1, a safety device of a curtain bead chain is revealed. A main fastener and an auxiliary fastener are used to connect two beads on two ends of a blind cord respectively, or a first shaft tube and a second shaft tube are mounted with a bead of the blind cord respectively. A sleeve is fitted over the first and the second shaft tubes so as to connect the beads on two ends of the blind cord respectively. Thus the blind is driven to extend or retract. When a user is tangled in the blind cord, the safety fastener can be pulled and released to prevent accidents such as suffocation. Yet the safety fastener is tube with a certain thickness. Thus the safety fastener is stopped outside the sprocket while in use and the blind cord with beads is unable to be operated circularly. This causes inconvenience in use.

Also refer to Chinese Pat. No. 203452629U, a safe separator of a curtain bead chain is revealed. The safe separator of the curtain bead chain includes a main body connected to the curtain bead chain. The safe separator of the curtain bead chain features on that a first end of the main body is connected to a first free end of the curtain bead chain while a second end of the main body is connected to a second free end of the curtain bead chain. The second end of the main body is arranged with a hemispherical recess for mounting a bead of the curtain bead chain. The diameter of the hemispherical recess is smaller than that of the bead of the curtain bead chain. For mounting and stopping the bead of the curtain bead chain, the size of the main body of the safe separator is larger than the bead of the curtain bead chain. The main body of the safe separator is also unable to pass through a sprocket and move circularly.

Thus there is room for improvement and a need to provide a safety bead chain for blinds that overcomes the above shortcomings.

### SUMMARY OF THE INVENTION

Therefore it is a primary object of the present invention to provide a safety bead chain for blinds in which two ends thereof are separated when a force applied is larger than the load of the bead chain. Moreover, the bead chain is moved around the sprocket in a circular manner.

In order to achieve the above object, a safety bead chain of the present invention includes an external member and a mounting member arranged at two ends of the bead chain respectively. The external member consists of a groove and at least two first locking parts arranged around the groove. The mounting member is set with at least two second locking parts locked with the first locking parts correspondingly. The two ends of the bead chain connected by the first and second locking parts are released from each other when a pulling force larger than the load of the bead chain is applied to the bead chain so as to prevent children from getting tangled in the bead chain.

The first locking part is a protrusion projected and extended from the circumference of the groove while the second locking part is a slot corresponding to the protrusion.

The first locking part is a slot formed at the circumference of the groove while the second locking part is a protrusion corresponding to the slot.

Compared with the structure available now, the present invention has the following advantages:

1. When the bead chain for blinds of the present invention is pulled by an external force such as the child pulls the bead chain down on his neck, the two ends of the bead chain are separated once the pulling force is larger than the connection force by which the first locking parts and the second locking parts are engaged and locked with each other. Thus the bead chain is in an open state and this prevents the bead chain from wrapping around the child's neck and causing suffocation or strangulation to ensure children's safety

2. In the safety bead chain of the present invention, the safety bead fastener with the same size of the bead is formed by engagement and locking of the external member with the mounting member. After the bead chain being mounted on the sprocket, the bead chain is moved around the sprocket in a circular manner. The user can operate the bead chain for the blinds more conveniently.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is perspective view of an embodiment according to the present invention;

FIG. 2 is a schematic drawing showing an embodiment assembled with a sprocket while in use according to the present invention;

FIG. 3 is an explosive view of an embodiment according to the present invention;

FIG. 4 is an exploded longitudinal sectional view of an embodiment according to the present invention;

FIG. 5 is a longitudinal sectional view of an embodiment according to the present invention;

FIG. 6 is a longitudinal sectional view of another embodiment according to the present invention.

### DETAILED DESCRIPTION OF THE PREFERRED EMBODIMENT

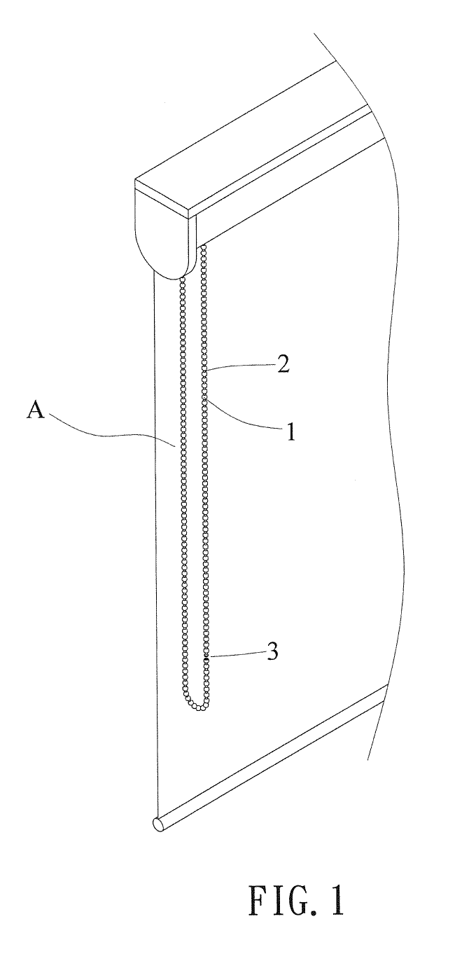

Refer from FIG. 1 to FIG. 4, a safety bead chain A for blinds of the present invention mainly includes a plurality of beads 1, a cord 2, and a safety bead fastener 3.

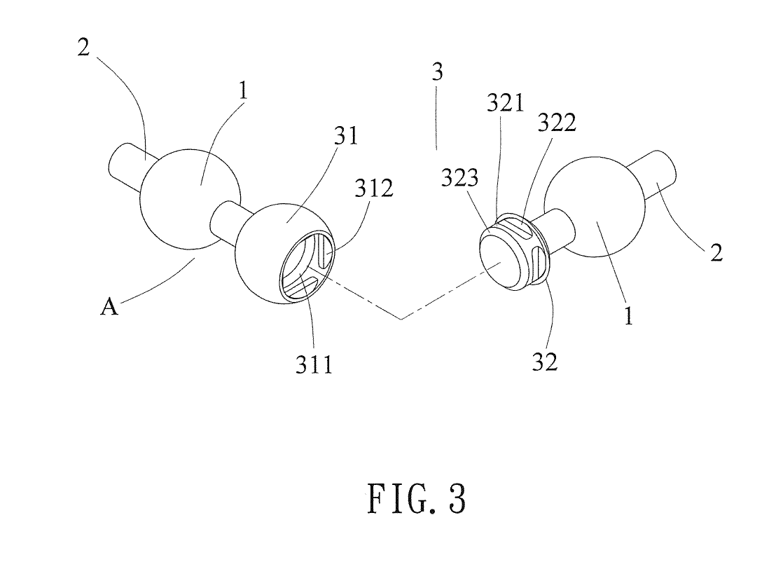

Refer to FIG. 3, the safety bead fastener 3 consists of an external member 31 and a mounting member 32. The external member 31 is a ball with the same diameter of the bead 1 and having about two thirds (⅔) to three fourths (¾) the volume of the bead 1. One end of the external member 31 is connected to a first end of the cord 2 of the bead chain A while the other end thereof is disposed with a groove 311 and at least two first locking parts 312 arranged around the groove 311.

One end of the mounting member 32 is connected to a second end of the cord 2 of the bead chain A while the other end thereof is set with a mounted portion 321 corresponding to the groove 311 of the external member 31. A guiding slope 323 is formed on a front edge of the mounted portion 321 while at least two second locking parts 322 corresponding to and locked with the first locking parts 312 of the external member 31 are arranged around the mounted portion 321. Thus the external member 31 and the mounting member 32 are mounted and connected to each other to form the safety bead fastener 3 with the same shape as the bead 1, without rotating in relation to each other.

While in use, the bead chain A for blinds is formed by a plurality of beads 1 passed through by and fixed on the cord 2. The bead chain A for blinds i s an open-type head chain and the safety bead fastener 3 is disposed on an open end of the bead chain A for blinds so as to connect two ends of the bead chain A for blinds and form a close bead chain.

During assembly, two ends of the open-type bead chain A for blinds are connected to the external member 31 and the mounting member 32 respectively. Then the bead chain A for blinds is inserted into and wound around a sprocket 4. By the mounted portion 321 of the mounting member 32 mounted into the groove 311 of the external member 31 correspondingly and the guiding slope 323 on the front edge of the mounted portion 321, the first locking parts 312 and the second locking parts 322 are engaged and locked with each other when only a bit force is applied. Thus the two ends of the bead chain A for blinds are connected to form a close bead chain.

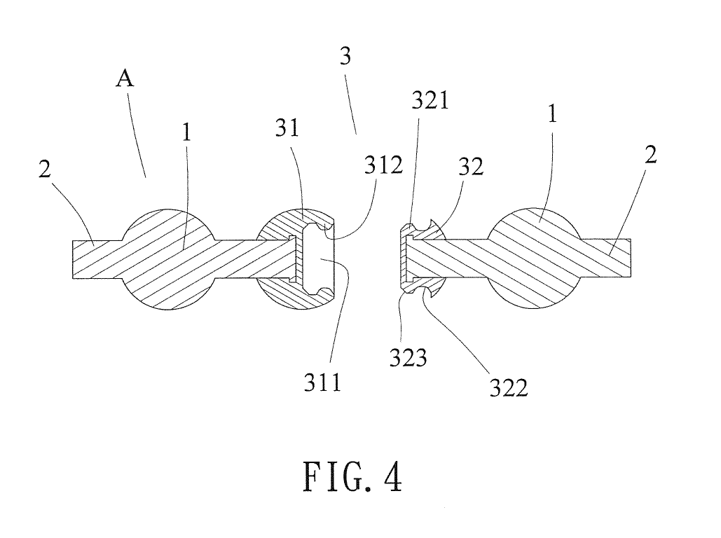

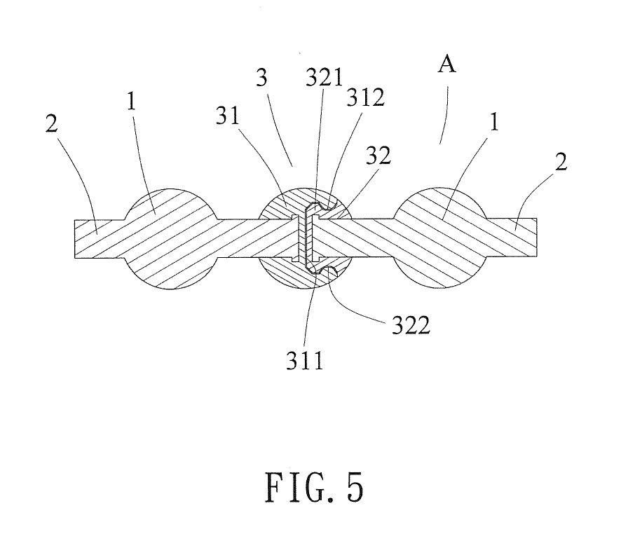

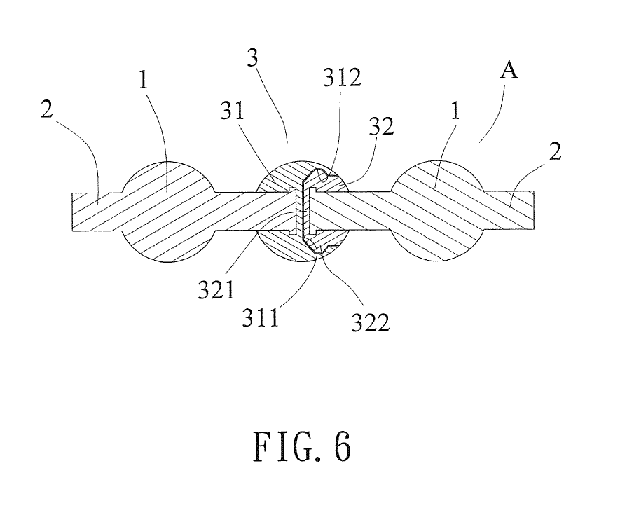

Refer from FIG. 3 to FIG. 6, the first locking part 312 and the second locking part 322 have two different forms. As shown in FIG. 4 and FIG. 5, each first locking part 312 is a protrusion projected and extended from a circumference of the groove 311 while each second locking part 322 is a slot corresponding to the protrusion. Refer to FIG. 6, each first locking part 312 is a slot formed at a circumference of the groove 311 while each second locking part 322 is a protrusion corresponding to the slot.

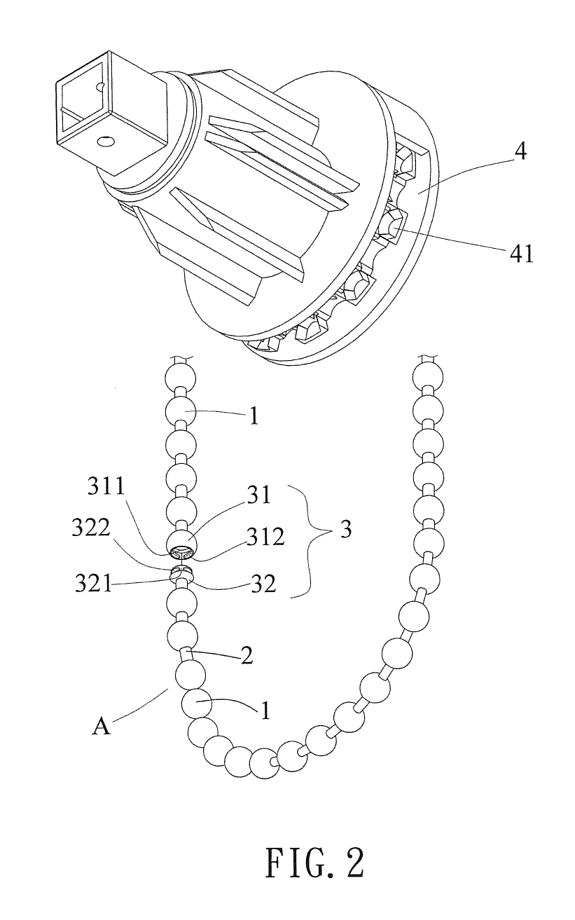

While in use, the bead chain A for blinds is inserted into and wound around the sprocket 4, as shown in FIG. 2. By pulling the bead chain A for blinds, a toothed disc 41 is driven to rotate. The safety bead fastener 3 formed by the external member 31 assembled with the mounting member 32 has the same shape and size as those of the bead 1. This allows circulating movement of the bead chain A for blinds. The safety bead fastener 3 will not be locked outside the sprocket 4 and restricted by a travel length thereof The sprocket 4 is driven by the safety bead fastener 3 to rotate freely. During the pulling process, a pulling force is generated once a child's neck gets tangled in the bead chain A for blinds. When the pulling force is larger than a connection force by which the first locking parts 312 and the second locking parts 322 are engaged and locked with each other, the external member 31 and the mounting member 32 are separated from each other. The two ends of the bead chain A for blinds are released from each other and the bead chain A for blinds is in an open state. The design can prevent children from getting tangled in the bead chain A for blinds.

In summary, the present invention has the following advantages compared with the structure available now:

1. When the bead chain for blinds of the present invention is pulled by an external force such as the child gets tangled in the bead chain, the two ends of the bead chain are released once the pulling force is larger than the connection force by which the first locking parts and the second locking parts are engaged and locked with each other. Thus the bead chain is in an open state and the child would not strangle in the cord and the bead chain loops to ensure children's safety.

2. In the safety bead chain of the present invention, the safety bead fastener with the same size of the bead is formed by engagement and locking of the external member with the mounting member. After the bead chain being inserted into and wound around the sprocket, the bead chain is moved around the sprocket in a circular manner. The user can operate the bead chain for the blinds more conveniently.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A safety bead chain for blinds comprising a plurality of beads, a cord passed through the beads to form a bead chain, and a safety bead arranged at the bead chain; wherein the safety bead fastener includes:
an external member that is a ball with the same diameter of the bead and having about two thirds to three fourths volume of the bead; one end of the external member is connected to a first end of the cord of the bead chain while the other end of the external member is disposed with a groove and at least two first locking parts arranged around the groove;
a mounting member in which one end thereof is connected to a second end of the cord of the bead chain while the other end thereof is set with a mounted portion and at least two second locking parts arranged around the mounted portion; the mounted portion is corresponding to the groove of the external member while the second locking parts are locked with and connected to the first locking parts of the external member correspondingly; the external member and the mounting member are connected to form the safety bead fastener with the same shape as the bead of the bead chain while the external member and the mounting member will not rotate in relation to each other.

2. The safety bead chain for blinds as claimed in claim 1, wherein a guiding slope is formed on a front edge of the mounted portion.

3. The safety bead chain for blinds as claimed in claim 1, wherein each first locking part is a protrusion projected and extended from a circumference of the groove while each second locking part is a slot corresponding to the protrusion.

4. The safety bead chain for blinds as claimed in claim 1, wherein each first locking part is a slot formed at a circumference of the groove while each second locking part is a protrusion corresponding to the slot.

5. The safety bead chain for blinds as claimed in claim 2, wherein each first locking part is a protrusion projected and extended from a circumference of the groove while each second locking part is a slot corresponding to the protrusion.

6. The safety bead chain for blinds as claimed in claim 2, wherein each first locking part is a slot formed at a circumference of the groove while each second locking part is a protrusion corresponding to the slot.
